(19) United States
(12) Patent Application Publication
(10) Pub. No.: US 2013/0037171 A1
(43) Pub. Date: Feb. 14, 2013

(54) Combined Feed Roller and Conveyor Sprocket/Pulley for a Tree Chipper

(71) Applicant: James L. O'Halloran, Pella, IA (US)

(72) Inventor: James L. O'Halloran, Pella, IA (US)

(21) Appl. No.: 13/206,326

(22) Filed: Aug. 9, 2011

(51) Int. Cl. B65G 23/44

(52) U.S. Cl. 144/242.1

(57) ABSTRACT

A log/tree chipper having an infeed with a roller member, such as a sprocket or pulley, guides a chain has at least one lug in the roller member, such lug extending above the outer surface of the chain and above a feed table. One or more auxiliary feed members with lugs can rotate with and along the same axis of rotation of the roller member and be spaced to one side of a roller member. The auxiliary feed member can be positioned at the material exit end of a feed table, or at both ends of a feed table. Lugs on the auxiliary feed members and/or the roller members/sprockets are, in some embodiments, positioned at the material exit end of the feed table work so as to work in a symbiotic relationship with the main feed roller.

### CROSS REFERENCE TO RELATED APPLICATIONS

U.S. patent application Ser. No. 13/206,245, filed Aug. 9, 2011, entitled “INDIVIDUAL FEED CHAIN TENSION SYSTEM FOR TREE CHIPPER”, now U.S. Pat. No. ______, which is incorporated herein by reference in its entirety.

### BACKGROUND OF THE INVENTION

1. Field of the Invention

This invention relates to feed control for a log and/or tree chipper. More particularly, the invention relates to an apparatus for improving the feeding performance of the infeed system of a log and/or tree chipper without increasing the cost or complexity thereof by providing an additional feed roller under the main feed roller on the feed table of a log/tree chipper.

2. Background Art

The present state of the art in large log/tree chippers is to help assist feeding with an infeed conveyor on the feed table. The infeed conveyor is typically a series of WD style drag chains running side by side. The individual drag chains may have a small, occasional tooth welded to the side of the chain every four to eight links to assist in the movement of material. The chain runs around a head pulley and a tail pulley assembly. The head pulley is made up of a shaft with a wide sprocket welded to the shaft at every drag chain. The sprocket drives the infeed chain and the infeed chain moves the material to be fed. The lack of aggressive features means that the chain will move material laying on it as long as it does not meet restriction from other infeed features. If the material is restricted, then the chain and head pulley slip underneath the material and the upper feed roller is thereby forced to do all of the work. To solve this problem one manufacturer of this type of machine has begun to install a lower feed roller between the head pulley and the cutter drum shear bar. This lower feed roller has aggressive knives welded to the outside surface to bite into the wood like the top, main, feed roller. With this aforementioned arrangement, the wood is pinched between an upper and lower aggressive feed roller and is more likely to overcome restrictions as the wood is forced towards the cutter drum. A disadvantage is that this adds expense, complexity, and increased possibilities for failure. The additional expense is in the production of the added feed roller and the drive system for it. The additional complexity results from there being more parts required, especially in combining the drives effectively of the main feed roller and the added lower one. The increased failure points result from the use of the needed additional bearings, the drive system, also resulting in more locations for material to wrap around one of the additional shafts.

There is, therefore, a need for a method and apparatus for overcoming the aforementioned problems with prior art feed roller systems for large tree/log chippers.

### BRIEF SUMMARY OF THE INVENTION

In the present invention, fewer moving parts are used to solve the aforementioned feed roller problem by adding log engaging lugs on the pulley/sprocket closest to the feed roller instead of having both a pulley/sprocket nearest the feed roller and an additional feed roller that rotate on a different axis near the top of the feed table adjacent to the main feed roller.

The log/tree chipper has an infeed with a roller member, such as a sprocket or pulley, guides a chain has at least one lug in the roller member, such lug extending above the outer surface of the chain and above a feed table. One or more auxiliary feed members with lugs can rotate with and along the same axis of rotation of the roller member and be spaced to one side of a roller member. The auxiliary feed member can be positioned at the material exit end of a feed table, or at both ends of a feed table. Lugs on the auxiliary feed members and/or the roller members/sprockets are, in some embodiments, positioned at the material exit end of the feed table work so as to work in a symbiotic relationship with the main feed roller.

In some embodiments of the present invention an additional feed roller is placed to one side of one of the feed chain(s) on the feed table, instead of under the main feed roller as in the prior art, and in other embodiments such additional feed roller(s) is(are) placed adjacent one or more feed chains or conveyors on the feed table, with or without the additional lugs on the pulley/sprocket closest to the main feed roller, the additional feed roller(s) rotating about the same axis, and preferably even on the same shaft, as the adjacent pulley/sprocket.

### BRIEF DESCRIPTION OF THE DRAWINGS

FIG. 1 is a perspective view of a whole tree chipper constructed in accordance to the present invention with a feed table having two drag chains for moving logs/trees to a feed roller, and showing log engaging structures on sprockets and an auxiliary feed roller extending above the feed table adjacent the main feed roller;

FIG. 2 is a perspective view of the chipper of FIG. 1 with a portion of the feed table removed to show an feed chain trained around a powered drive sprocket near the feed roller and an idler sprocket at a material entrance end of the feed table;

FIG. 3 is an enlarged perspective view of the two chains and the drive system therefore of FIG. 1 with the feed table removed to show an feed chain trained around a powered drive sprockets near the feed roller and a idler sprockets at a material entrance end of the feed table;

FIG. 4 is a side elevational view of the chipper from the side of FIG. 2 with a portion of the feed table removed to show a chipper drum, the main feed roller, an feed chain trained around a powered drive sprocket near the feed roller and an idler sprocket at a material entrance end of the feed table;

FIG. 5 is an enlarged perspective view of the sprockets closest to the main feed roller as shown in FIG. 3, and also showing portions of the drive system that powers these sprockets;

FIG. 6 is a partial top view of the structure shown in FIG. 5;

FIG. 7 is a cross sectional view taken along line 7-7 of FIG. 6;

FIG. 8 is a cross sectional view taken along line 8-8 of FIG. 6;

FIG. 9 is an enlarged top view like FIG. 6, but showing mainly only those portions of the sprockets, chains and auxiliary feed roller that are located closest to the main feed roller;

FIG. 10 is an enlarged, partial side view taken from the right side of FIG. 6, and showing the phase difference between the first and second log engaging structures on the sprockets shown and the lugs on the auxiliary feed roller;

FIG. 11 is an exploded perspective view of the main feed roller and the system for mounting it to the frame of the machine, the arrow showing how the main feed roller can pivot up and down as material goes under it by pivoting a feed roller sub-frame which is pivotally attached to the main frame of the machine;

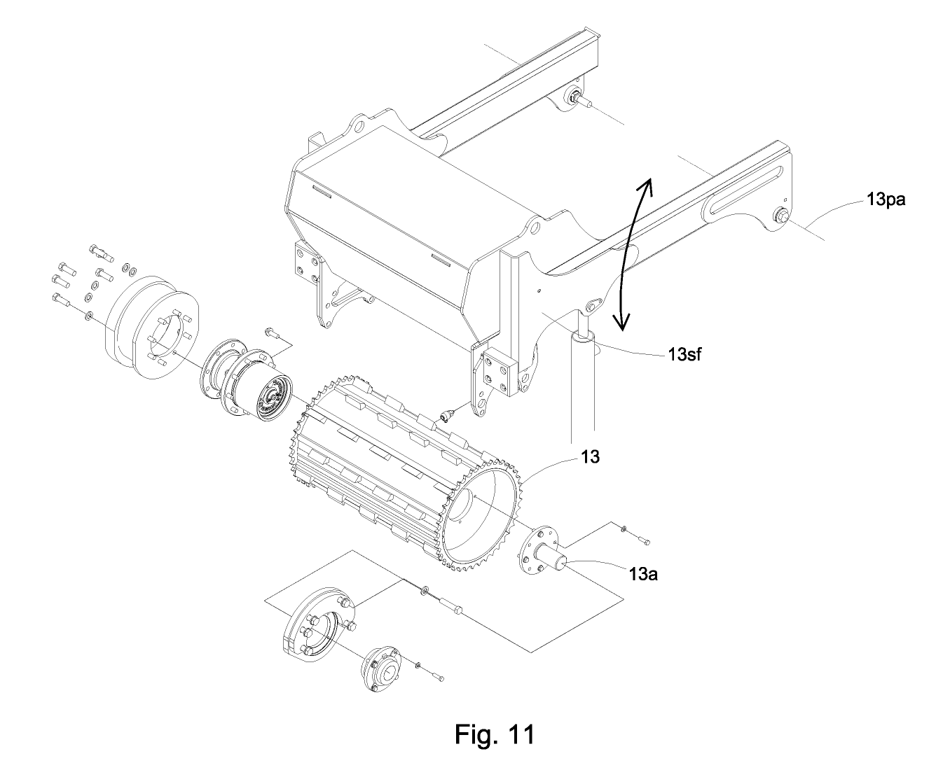

FIG. 12 is a top, somewhat schematic view, of the feed table, cutter drum, showing the two feed chains and the mounting sprockets that the chains are trained around;

FIG. 13, an alternate embodiment, shows a top, somewhat schematic view, of a feed table, cutter drum, showing only one feed chain and the mounting sprockets that the chain is trained around, and also including auxiliary feed rollers on each side of the sprockets closest to the main feed roller; and

FIG. 14, also an alternate embodiment, is similar to FIG. 13 except that a conveyor belt comprising a plurality of metal plates replaces the conveyor chain which conveyor belt is trained around pulleys which do not have log engaging structures on them like the sockets of the FIG. 13 embodiment, relying on an auxiliary feed roller on each side of the pulley adjacent the main feed roller to help feed the material from the feed table past the main feed roller and the feed table towards the cutter drum, the auxiliary feed rollers being attached to the pulley and rotating around the same axis as that pulley closest to the main feed roller;

FIG. 15, another alternate embodiment, is a cross sectional view similar to FIG. 4, but using another auxiliary feed structure, in addition to the essentially duplicate auxiliary feed member closer to the main feed roller, the additional auxiliary feed rotary member is attached to the idler sprocket for rotation with the idler sprocket and having lugs thereon extending radially outwardly between the chain links and above the feed table for contacting trees or logs as they enter the feed table and moving them towards the chipper drum; and

FIG. 16 is a top view of the FIG. 15 embodiment.

### DETAILED DESCRIPTION OF THE INVENTION

With reference now to the various figures in which identical elements are numbered identically throughout, a description of various exemplary aspects of the present invention will now be provided. The preferred embodiments are shown in the drawings and described with the understanding that the present disclosure is to be considered an exemplification of the invention and is not intended to limit the invention to the embodiments disclosed.

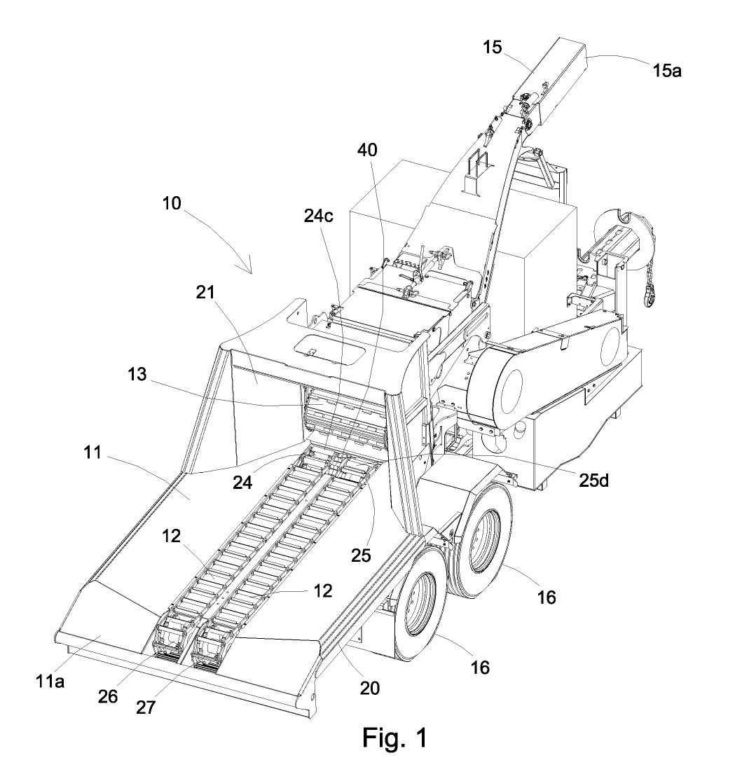

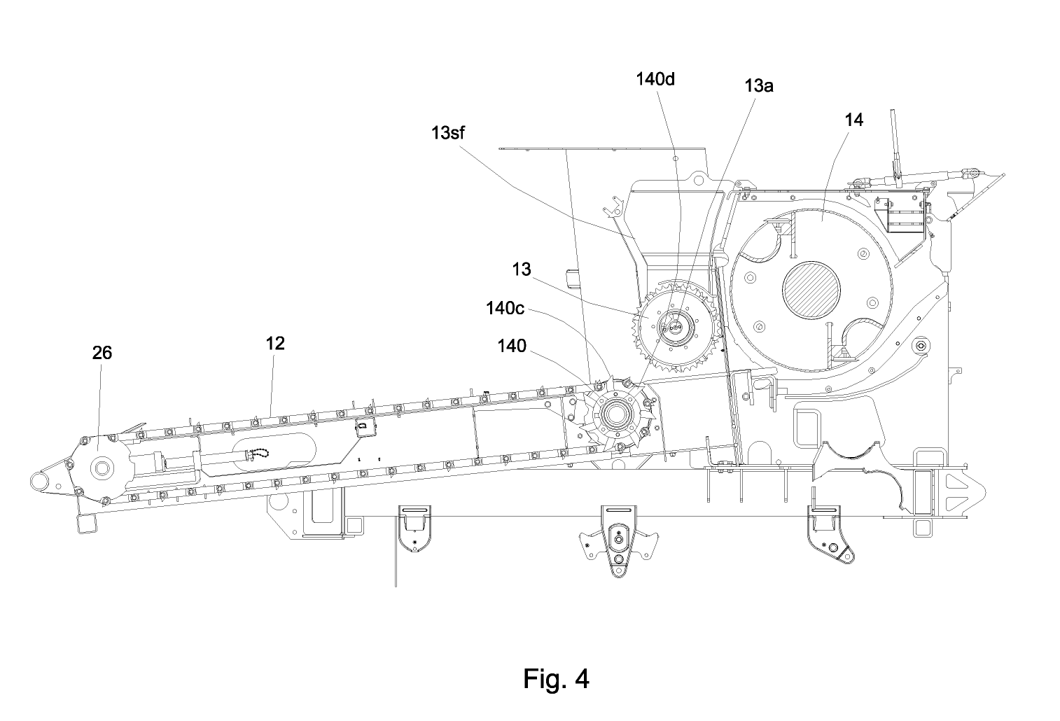

FIG. 1 shows log or whole tree chipper 10, with a feed table 11 having two feed chains 12 for moving trees or logs towards a feed roller 13. As in chippers in general, the feed roller 13 forces the logs or trees towards a chipping drum 14, as best shown in FIG. 4. The material reducing or chipping drum 14 cuts the wood into small chips and forces the small chips out a chute 15 as is typical of chippers of any size.

The brush chipper 10 is mounted on wheels 16 (FIG. 1), however, tracks and skids may also be used, and the brush chipper 10 may be stationary as well. The present invention is not limited to any particular conveyance apparatus, nor does it require the brush chipper 10 be portable.

Generally, the brush chipper 10 has a rear, feed end 11a and a front, outfeed end, 15a. A feed direction is defined, for the purposes of this document, including the claims, as the direction the brush is forced while it is being chipped; that is, the feed direction is the direction going from the feed end, or material entrance end at 11a, to the out feed, or material exit end, of the chipper 10, towards outfeed end 15a when the chute 15 is in the position shown in FIG. 1.

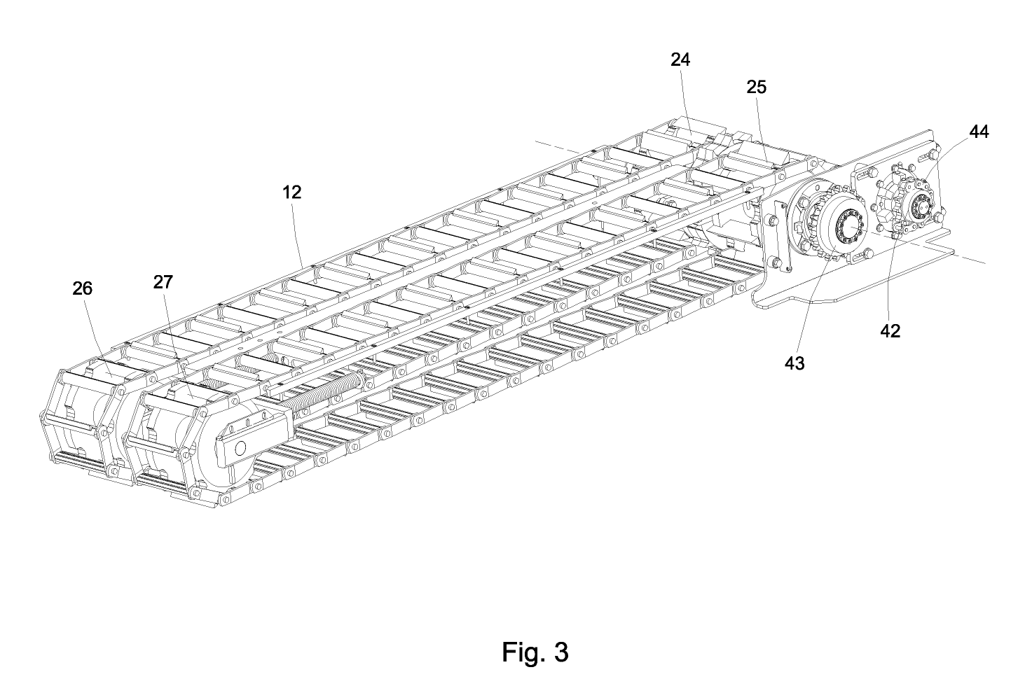

The brush chipper machine 10 for processing logs and whole trees has a frame 20. The material reducing drum 14, shown best in FIG. 3, is operatively rotatably attached to the frame 20. The feed table 11 is bolted to the frame 20 for receiving and supporting trees and logs thereon, the feed table 11 having a top, a bottom, a front end and a rear end.

Looking to FIG. 4, the feed roller 13 is disposed between the feed table 11 and the material reducing drum 14 and is rotatably attached to a sub-frame 13sf about rotational axis 13a. The sub-frame 13sf is pivotally attached about pivotal axis 13pa so that the feed roller 13 can move up or down as logs/trees move there under towards the material reducing drum 14.

FIG. 1 shows a pair of mostly vertical walls 21 on each side of the feed roller 13, the walls 21 having a front and a rear and being farther apart at the rear thereof than at the front thereof for funneling logs and trees from the feed table 11 to the feed roller 13 and eventually to the material reducing drum 14.

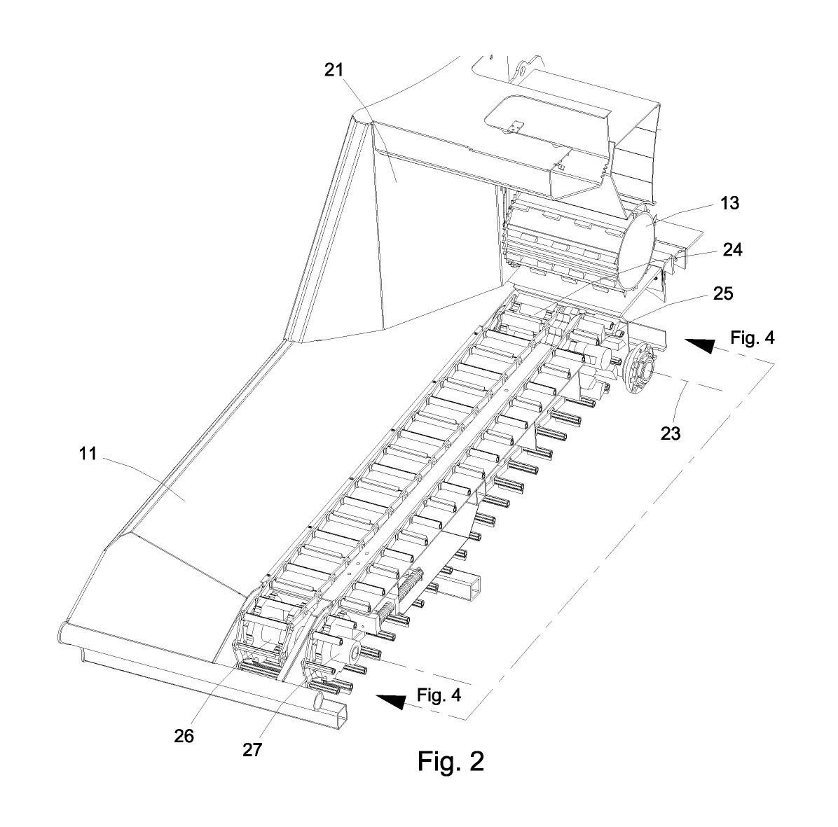

Looking to FIGS. 1 and 2, a first powered drive member, sprocket 24, (which could also be a pulley) is operatively rotatably attached to the frame along a first substantially a horizontal axis 23 located below the top, front end of the feed table 11. A second powered drive member, sprocket 25, (which could also be a pulley) is operatively rotatably attached to the frame along a second substantially horizontal axis located below the top, front end of the feed table 11, which second substantially horizontal axis can be coincident with the first substantially horizontal axis 23.

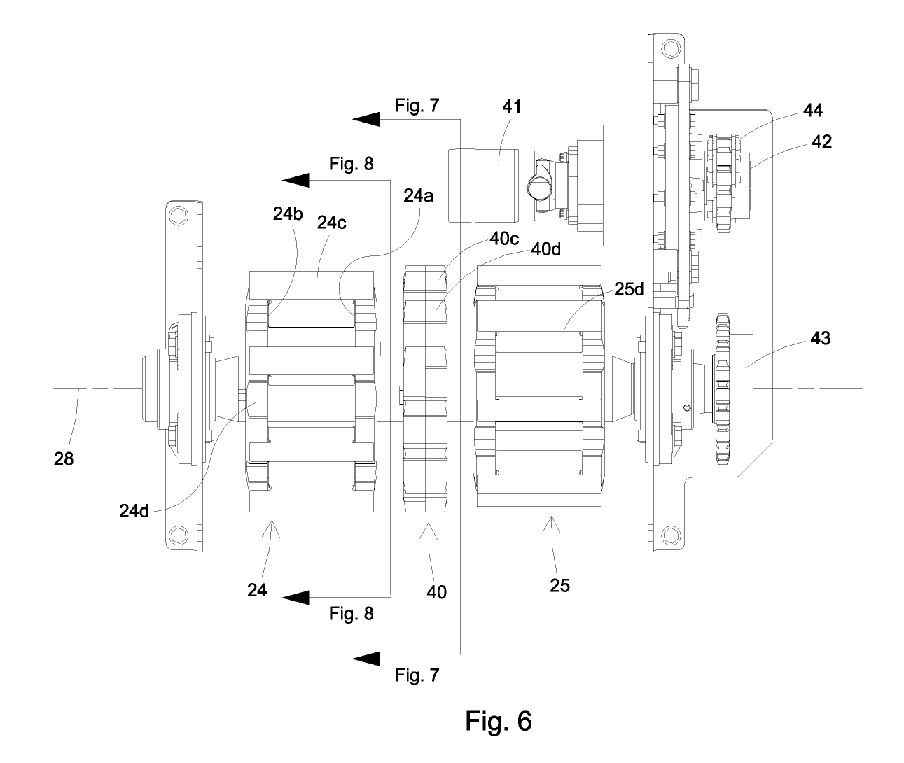

Looking now to FIGS. 1-6, a first idler member, sprocket 26 (which could also be a pulley type idler) is operatively rotatably attached to the frame along a third substantially horizontal axis 28 (FIG. 6) located below the top, rear end of the feed table 11. A second idler member 27 (sprocket or pulley) operatively rotatably attached to the the frame along a fourth substantially horizontal axis 29 (FIG. 6) located below the top, rear end of the feed table 11.

Looking now to FIGS. 1-4, there is a first feed conveyor chain 12, less than half the width of the feed roller 13, the first feed conveyor chain 12 being trained around the first powered drive member 24 and the first idler member 26 for selectively moving the logs and trees along the feed table 11 to the feed roller 13. A second feed conveyor chain 12 is also less than half the width of the feed roller 13, the second feed conveyor chain 12 being trained around the second powered drive member 25 and the second idler member 27 for selectively moving the logs and trees along the feed table 11 to feed table 13, the distance between the first substantially horizontal axis 23 and the third substantially horizontal axis 28 can be the same or can be a variable distance as disclosed in U.S. patent application Ser. No. 13/206,245, filed Aug. 9, 2011, now U.S. Pat. No. ______, which is incorporated herein by reference in its entirety.

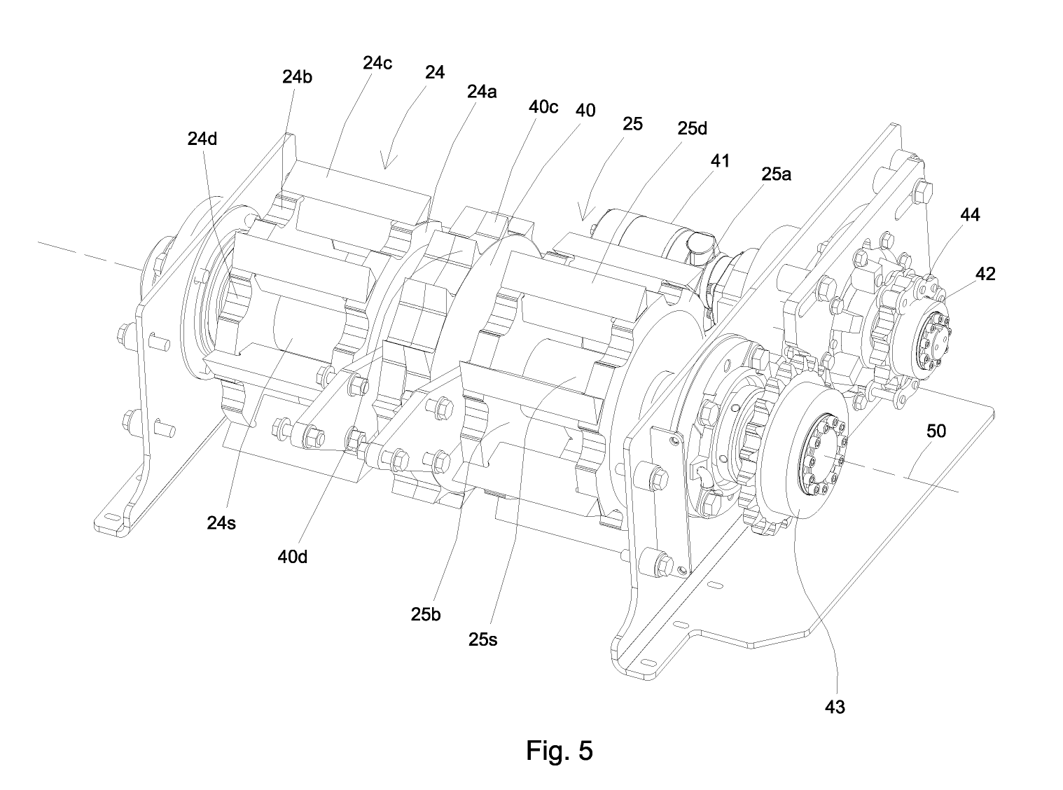

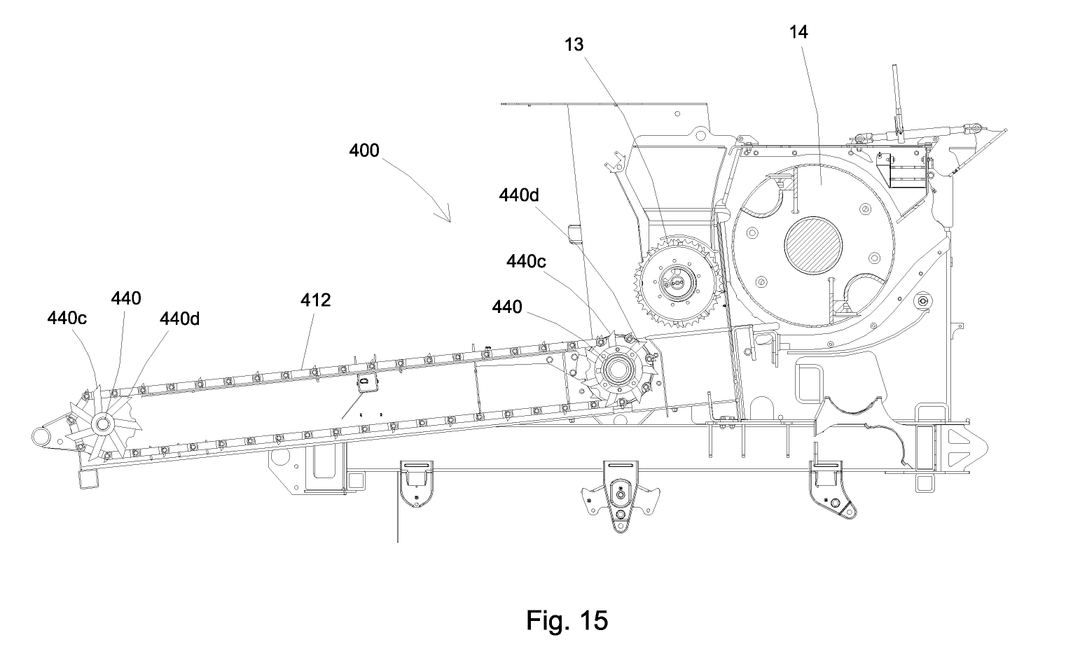

Looking at FIG. 5, a sprocket 24 has a rotating shaft 24s with discs 24a and 24b rigidly attached thereto so that when driven by hydraulic motor 41, sprocket 42 will turn, causing chain 44 to transmit that rotation to sprocket 43, which will rotate both sprockets 24 and 25. Sprocket 25 is constructed like sprocket 24, with a center shaft portion 25s, spaced apart discs 25a and 25b. Also rigidly turning with the sprockets 24 and 25 is an auxiliary feed member 40, shown in FIG. 5 as being made with two discs having lugs 40c and 40d alternatively around the exterior periphery thereof. Sprockets 24 and 25 and auxiliary feed member 40 are all rigidly attached to each other. The lugs 40c are in rotational phase with lugs 24c on the sprocket 24 so that the lugs 40c and lugs 24c work together as the assembly 24, 25 and 40 rotate, to push a tree or log towards the main feed roller 13 and ultimately on towards the cutter drum 14 shown in FIG. 15, for example. Similarly, lugs 25d on sprocket 25 are aligned in phase with the rotation of lugs 40d on auxiliary feed member 40. Every other lug on auxiliary feed member 40 is a lug 40c aligned with a corresponding lug 24c on sprocket 24 and every other lug 40d on auxiliary feed member 40 is a lug 40d that aligns with lugs 25d on sprocket 25. All of the lugs 40c and 40d are identical on the embodiment shown. Similarly, all of the lugs 24c and 25d are identical in the embodiment shown in FIG. 5, for example. By alternating the pushing of the log or tree between lugs 24c on one side and then alternatively lugs 25d on the other side sequentially, less hydraulic pressure is required than if all of the lugs 24c and 25d were pushing together at the same time instead of being out of phase with respect to each other as they rotate.

Looking at FIGS. 5 and 6, the lug structure 24c, 25d, 40c and 40d are all disposed for rotation about the first substantially horizontal axis 50, the lug structure 24c, 25d, 40c and 40d being operatively attached to and rotating with the first sprocket 24. This lug structure of lugs 24c, 25d, 40c and 40d is disposed above the feed table at times during rotation of the assembly of sprockets 24 and 25 and auxiliary feed member 40 so that the lugs contact material on the feed table and move the material towards the material exit end of the feed table, namely towards the main feed roller 13 and cutter drum 14. Locating these lugs 24c, 25d, 40c and 40d near the main feed roller 13 causes the lugs to work in close conjunction with the main feed roller 13 so they are much more effective than prior art auxiliary feed rollers such as feed rollers 22 as shown in FIG. 1 of U.S. Pat. No. Re31,048, for example. Lugs 24c, 25d, 40c and 40d push logs up and forward toward the main feed roller 13 while at the same time the main feed roller 13 is pushing down and pulling the log forward, towards the cutter drum 14, in close proximity to the forces applied by the lugs 24c, 25d, 40c and 40d.

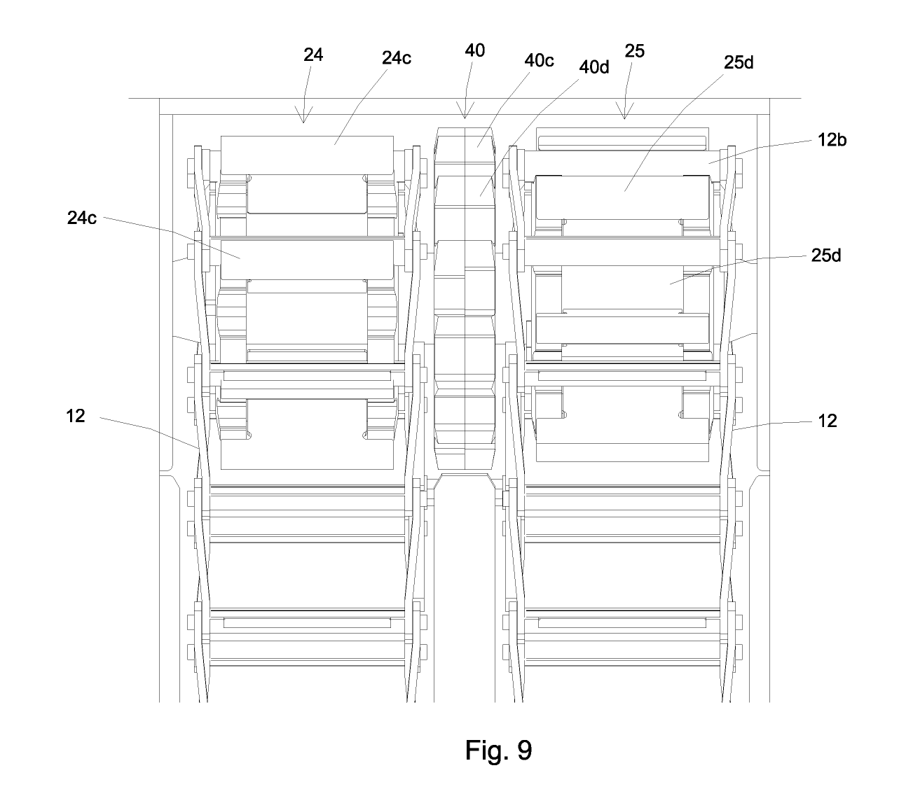

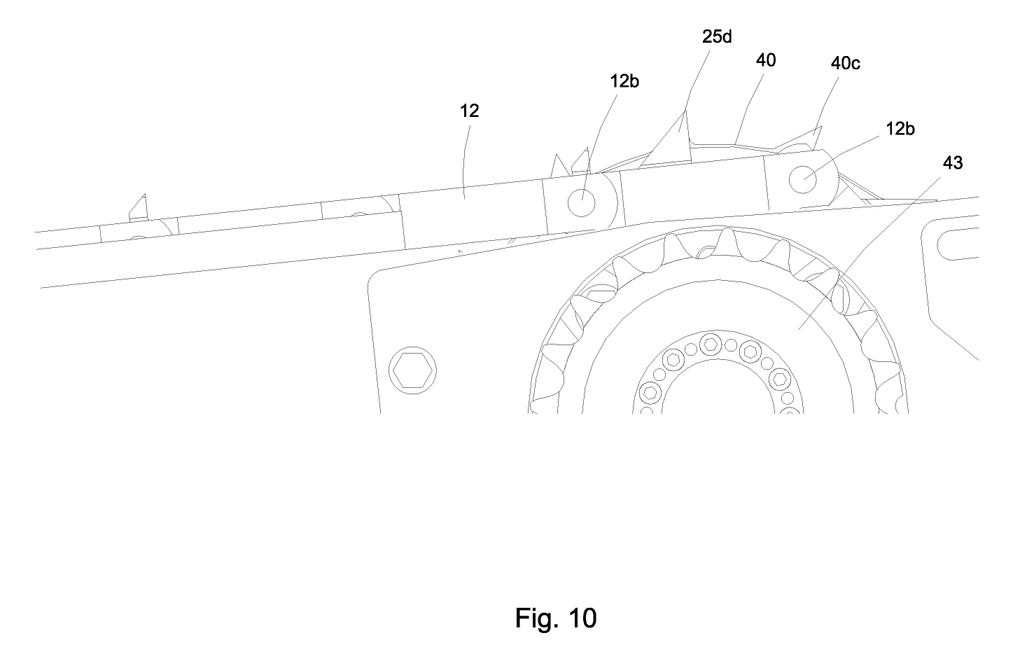

The chain 12 on the left as shown in FIG. 1, has bars 12b (FIGS. 9 and 10) that extend across the sprocket 24 and ride in grooves 24d as shown in FIG. 5. Between each depression or groove 24d in the discs 24a, 24b the lugs 24c are welded at each end thereof to the discs 24a and 24b. These lugs 24c therefore stick up through openings in the chains 12 as shown in FIGS. 1, 2, 3, 9 and 10. The same thing is happening with the chain 12 and lugs 25d welded to discs 25a and 25b, since in the embodiment shown sprockets 24 and 25 are essentially identical except for being mounted to rotate together with the respective lugs 24c and 25d out of phase with each other.

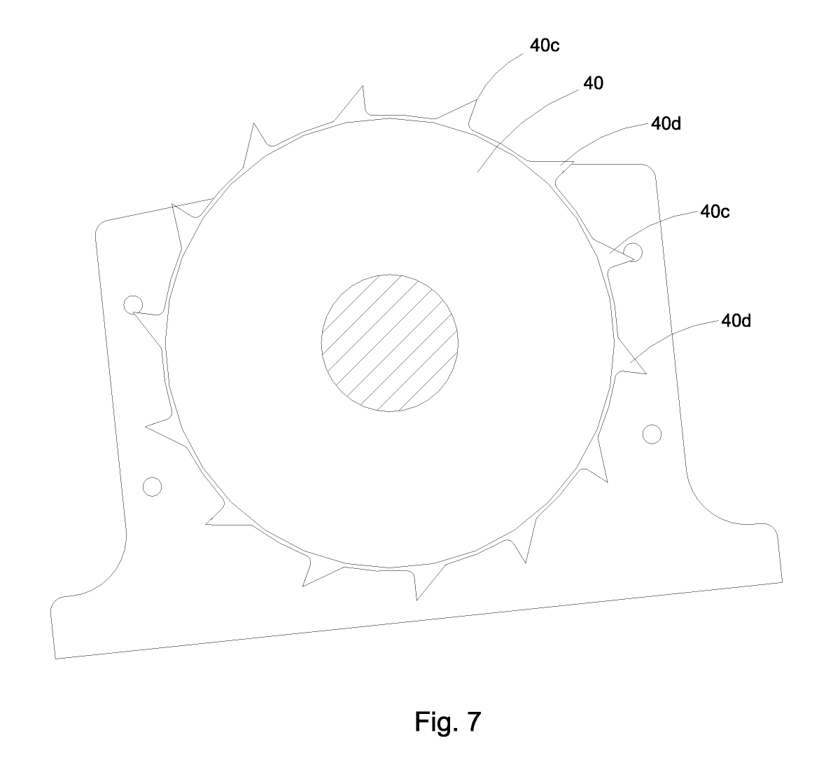

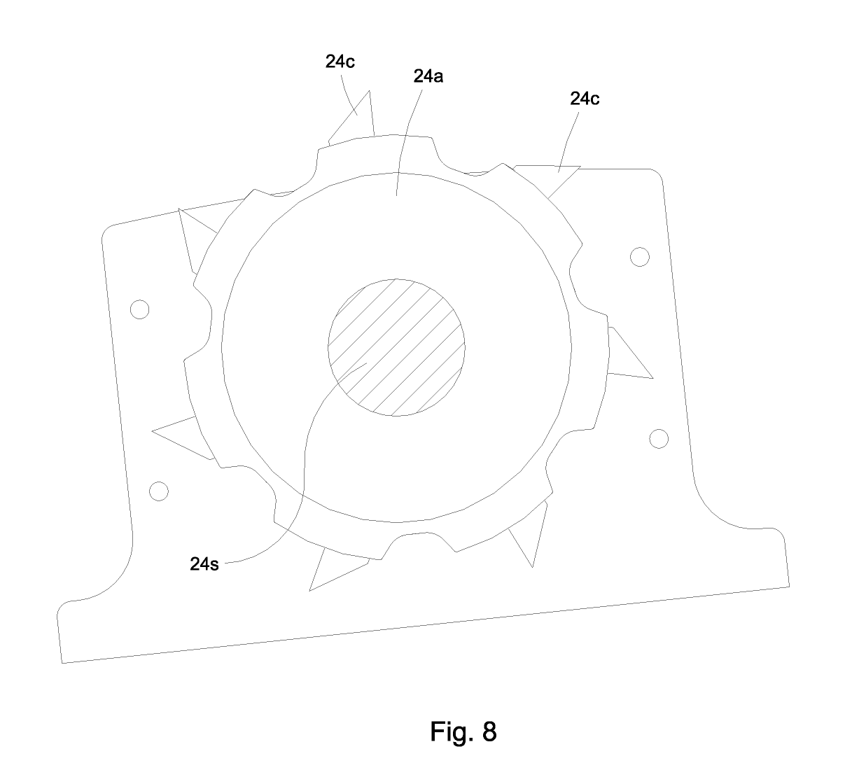

In FIG. 4, the auxiliary feed member 140 is of a different configuration than the auxiliary feed member 40 shown in FIGS. 1-3 and 5-9, but the lugs 140c and 140d work just the same as lugs 40c and 40d on auxiliary feed member 40 and are in phase with lugs 24c and 25d respectively.

The relative widths of the discs 24a and 24b with respect to the much wider lugs 24c is significant, thereby allowing for much more area to catch and push a log than if lugs 24c were just radially outward extensions of the same width as discs 24a and 24c. So the structure of lugs 24c, extending up through openings in the open chain 12 provides significant advantages over the prior art. Since sprockets 24 and 25, except for being out of phase, are identical, the same advantages accrue to lugs 25d on sprocket 25 as lugs 24c do on sprocket 24.

Also, the relative narrow width of auxiliary feed rollers 40 and 140 as compared to the lugs 24c and 25d on sprockets 24 and 25 permits all of these lugs 24c, 25d, 40c and 40d to all fit in a relatively narrow space on the feed table adjacent the material exit end of the feed table adjacent the main feed roller 13, with the lugs 24c and 25d in a preferred embodiment being at least twice as wide as lugs 40c and 40d. While this is an optimum arrangement, there are significant advantages to having even one set of lugs 24c, 25d, 40c or 40d on the feed table 11 and not any of the other ones. Any combination of use of the lugs 24c, 25d, 40c or 40d sticking up through the feed table 11 would be helpful to keeping the material moving to the main feed roller 13 and to the cutter wheel 14.

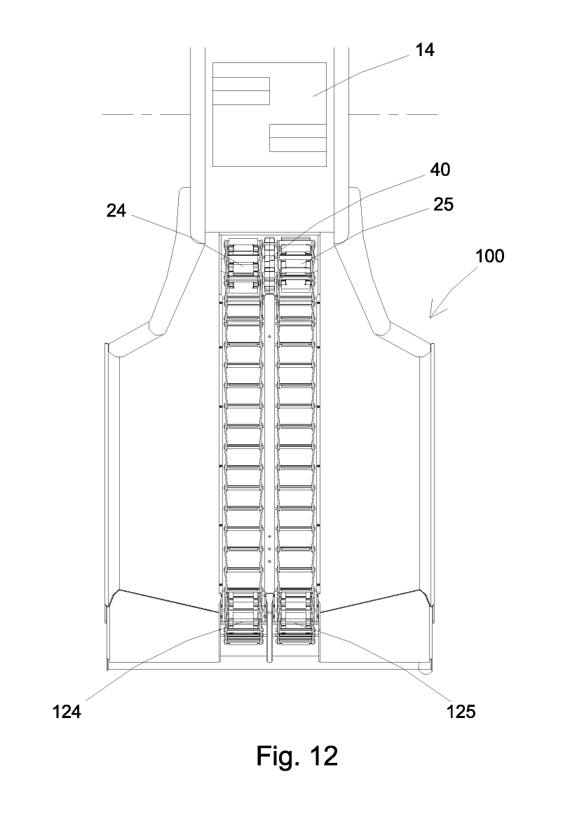

FIG. 12 shows an alternate embodiment 100 where sprockets 124 and 125 at the material entrance end of the feed table 11 are identical to the sprockets 24 and 25 at the material exit end except that the sprockets 124 and 125 are idler sprockets instead of driven sprockets. So the lugs on these sprockets 124 and 125 will also push logs on the feed table toward the cutter drum 14.

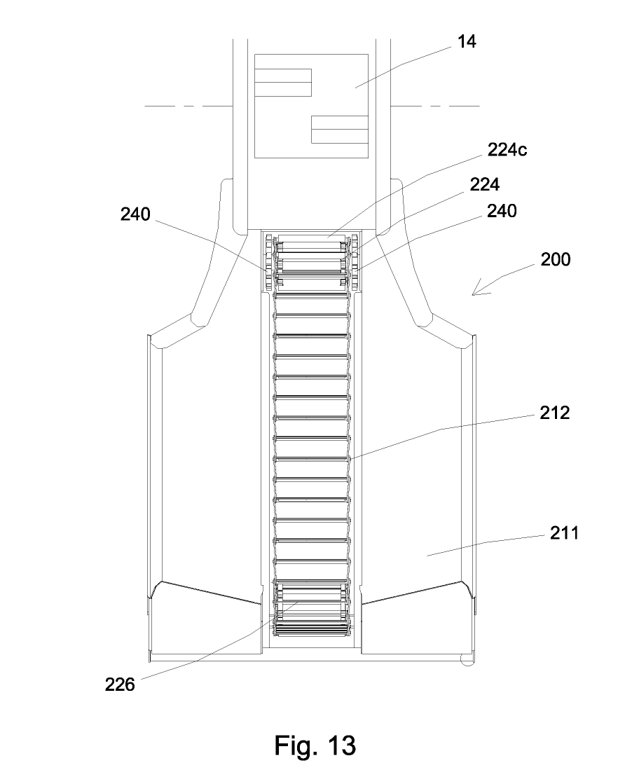

FIG. 13 shows an alternate embodiment 200 with a front sprocket 224 that is like sprocket 24 of FIGS. 1-10, except that it is wider. Also, there are two auxiliary feed rollers 240 that are like auxiliary feed roller 40 of FIG. 5, but relatively narrower. So logs on the feed table 211 would be moved by the chain 212 towards the lugs 224c on roller 224 and those lugs 224c, in conjunction with the lugs on auxiliary feed rollers 240 will push the log towards the main feed roller 13 and towards the cutter drum 14.

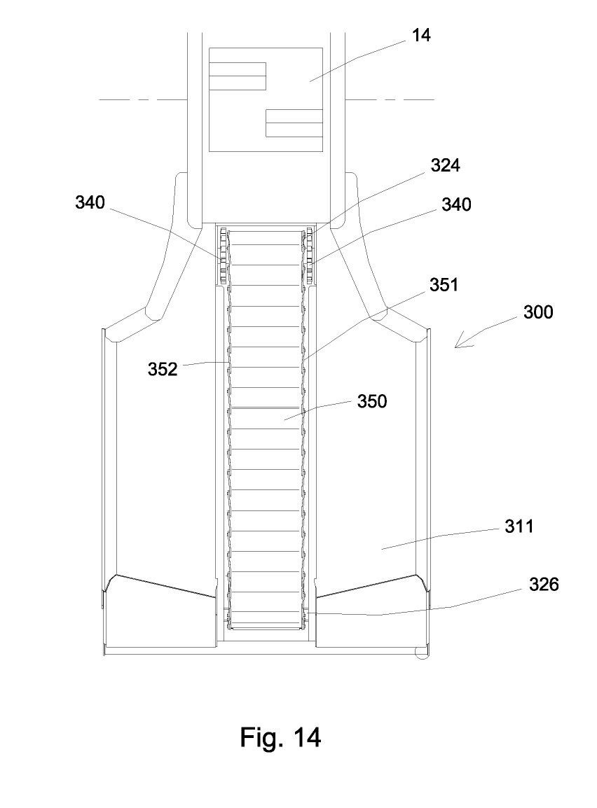

FIG. 14 is an alternate embodiment 300 showing an infeed table 311 having metal plates 350 between the two chains 351 and 352, to function like a solid conveyor, so that all that is seen in FIG. 14 are the joints between the metal plates, with chains 351 and 352 on each side of the plates 350. This type of conveyor would not be able to have lugs extending through these plates 350, but having the auxiliary feed rollers 340 provides significant advantages as explained above. Pulleys 324 and 326 are provided to keep the conveyor in place and permitting one of the pulleys 324 and 326 to be a driven pulley.

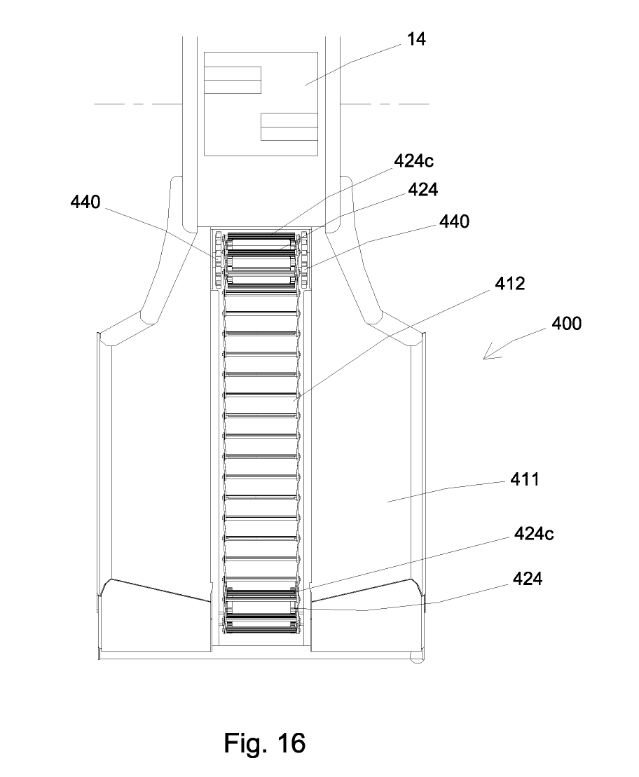

FIGS. 15 and 16 show an alternate embodiment 400 that is essentially like embodiment 200 in FIG. 13, except that the rear sprocket is the same as the front sprocket, one being driven and the other one being an idler sprocket. The alternate embodiment 400 has a front sprocket 424 that is like sprocket 24 of FIGS. 1-10, except that it is wider. Also, there are two auxiliary feed rollers 440 that are like auxiliary feed roller 40 of FIG. 5, but relatively narrower. So logs on the feed table 411 would be moved by the chain 412 towards the lugs 424c on roller 424 and those lugs 424c, in conjunction with the lugs on auxiliary feed rollers 440 will push the log towards the main feed roller and towards the cutter drum 14.

The above described embodiments are the preferred embodiments, but this invention is not limited thereto. It is, therefore, apparent that many modifications and variations of the present invention are possible in light of the above teachings. It is, therefore, to be understood that within the scope of the appended claims, the invention may be practiced otherwise than as specifically described.

1. A machine for processing logs and whole trees comprising:
a frame;
a material reducing drum operatively attached to the frame;
a feed table operatively attached to the frame for receiving and supporting trees and logs thereon, the feed table having a top, a bottom, a material entrance end and a material exit end;
a pair of mostly vertical walls on each side of the material reducing drum, the walls having a front and a rear and being farther apart at the material exit end of the feed table than at the material entrance end thereof for funneling logs and trees from the feed table to the material reducing drum;
a feed roller rotatably disposed between the feed table and the material reducing drum;
a first sprocket operatively rotatably attached to the frame along a first substantially horizontal axis located below the top of the feed table and closer to the material exit end than to the material entrance end of the feed table;
a second sprocket operatively rotatably attached to the frame along a second substantially horizontal axis located lower than the top of the feed table;
an infeed conveyor chain, the infeed conveyor chain being in operative contact with the first and second sprockets for selectively moving the logs and trees along the infeed table towards the material reducing drum when the first and second sprockets rotate; and
a lug structure disposed for rotation about the first substantially horizontal axis, said lug structure being operatively attached to and rotating with the first sprocket, said structure being disposed above the feed table at times during rotation of the first sprocket for contacting material on the feed table and moving the material towards the material exit end of the feed table.

2. The machine of claim 1 wherein the lug structure comprises: a disc operatively attached to the first sprocket and to one side of the first sprocket in a direction along the rotary axis of the first sprocket, said disc having a plurality of lugs disposed around the periphery of the disc that extend above the feed table.

3. The machine of claim 2 wherein the discs have a width and the first sprocket has a width, the width of the disc being less than the width of the first sprocket.

4. The machine of claim 3 wherein a second conveyor chain and a second set of sprockets for the second conveyor chain are disposed on the feed table and the disc with a lug structure on it is disposed between the first said conveyor chain and the second conveyor chain.

5. The machine of claim 1 wherein the lug structure comprises: lugs attached directly to the first sprocket.

6. The machine of claim 3 wherein the conveyor chain is an open conveyor chain and the lugs extend radially outwardly through openings in the conveyor chain.

7. The machine of claim 4 wherein first sprocket comprises spaced apart sections, an outer periphery of the spaced apart sections including chain engaging parts for contacting and driving the chain and the lugs extending between the spaced apart sections of the first sprocket.

8. A machine for processing logs and whole trees comprising:
a frame;
a material reducing drum operatively attached to the frame;
a feed table operatively attached to the frame for receiving and supporting trees and logs thereon, the feed table having a top, a bottom, a material entrance end and a material exit end;
a pair of mostly vertical walls on each side of the material reducing drum, the walls having a front and a rear and being farther apart at the material exit end of the feed table than at the material entrance end thereof for funneling logs and trees from the feed table to the material reducing drum;
a feed roller rotatably disposed between the feed table and the material reducing drum;
a first rotary member operatively rotatably attached to the frame along a first substantially horizontal axis located below the top of the feed table and between the material entrance end and the material exit end of the feed table;
a second rotary member operatively rotatably attached to the frame along a second substantially horizontal axis located lower than the top of the feed table;
an infeed conveyor, the infeed conveyor being trained around in operative contact with the first and second rotary members for selectively moving the logs and trees along the infeed table towards the material reducing drum when the first and second rotary members rotate; and
a lug structure disposed about the first substantially horizontal axis, said lug structure being operatively attached to and rotating with the first rotary member, said lug structure being disposed above the entrance and exit ends of the feed table at times during rotation of the first rotary member for contacting material on the feed table and moving the material towards the material exit end of the feed table.

9. The machine of claim 8 wherein the lug structure comprises lugs attached directly to the first rotary member.

10. The machine of claim 9 wherein the conveyor is an open conveyor chain and the lugs extend radially outwardly through openings in the conveyor chain.

11. The machine of claim 10 wherein first rotary member comprises a sprocket with spaced apart sections, an outer periphery of the spaced apart sections including parts for contacting and driving the chain conveyor and the lugs extending between the spaced apart sections of the first sprocket.

12. The machine of claim 8 wherein the conveyors comprise chains and the rotary members comprise sprockets.

13. The machine of claim 8 wherein the conveyors comprise a conveyor belt and the rotary members comprise pulleys or idlers.

14. The machine of claim 8 wherein the lug structure comprises a disc operatively attached to the first rotary member and to one side of the first rotary member in a direction along the rotary axis of the first sprocket, said disc having a plurality of lugs disposed around the periphery of the disc that extend above the feed table.

15. The machine of claim 14 wherein the discs have a width and the first rotary member has a width, the width of the disc being less than the width of the first sprocket.

16. The machine of claim 15 wherein a second conveyor and a second set of matching rotary members for the second conveyor are disposed on the feed table and the disc with a lug structure on it is disposed between the first said conveyor and the second conveyor.

17. The machine of claim 8 wherein the lug structure comprises: lugs attached directly to the first sprocket.

18. The machine of claim 8 wherein the conveyor is an open conveyor chain and the lugs extend radially outwardly through openings in the conveyor chain.

19. The machine of claim 9 wherein roller member comprises spaced apart sections, an outer periphery of the spaced apart sections including chain engaging parts for contacting and driving a chain and the lugs extending between the spaced apart sections of the first sprocket.

20. The machine of claim 8 wherein the first rotary member is closer to the material exit end than to the material entrance end of the feed table.

21. The machine of claim 8 wherein a second conveyor and a second set of roller members for the second conveyor are disposed on the feed table and the disc with a lug structure on it is disposed between the first said conveyor and the second conveyor.

22. The machine of claim 21 wherein the first said and second conveyors comprise open conveyor chains and the lugs extend radially outwardly through openings in the conveyor chains and the rotary members are sprockets with chain engaging parts for contacting and driving the chains and the lugs extend between the spaced apart sections of the sprockets.

23. The machine of claim 22 wherein a first plane extending through the first substantially horizontal axis on which two adjacent sprockets rotate and through a first lugs on one of the lugs on one of the sprocket of such adjacent sprockets is at an angle to a second plane extending through a lug of the second sprocket so that the first and second lugs engage a log sequentially at different times.

24. The machine of claim 24 wherein the disc rotatably disposed between the two adjacent sprockets and also rotating about the first substantially horizontal axis with those two sprockets has lugs disposed in the first and second plane.

25. An infeed system for a machine having a device used to comminute materials, the infeed system comprising a first end adjacent the device used to comminute the materials and a second end spaced a distance from the first end, the first and second ends spaced apart a distance adequate so that the infeed system is able to support the material, the infeed system including a conveyor system extending from second end to the first end capable of moving material in a direction from the second end towards the first end, the infeed system further having a rotary member disposed for rotation about a rotational axis, the rotary member being further disposed at the first end of the infeed system with a first portion of the rotary member extending a first distance radially outwardly in direct contact with the conveyor system to provide support for the conveyor system without directly contacting the material, the first portion having a first width, and a second portion of the rotary member extending radially outwardly at a second distance greater than the first distance so as to be constructed to directly contact the material.

26. The infeed system of claim 25 wherein the second portion of the rotary member is a disc, with a width less than the first width of the first portion of the rotary member that supports the conveyor, the second portion being located to one side of the first portion in a direction along the axis of rotation of the rotary member, the second portion having teeth for being in direct contact with the material to be comminuted.

27. The infeed system of claim 26 wherein the conveyor is an open chain and the second portion of the rotary member is an extension of the first portion that supports the conveyor, the second portion extending radially outwardly from the rotational axis between the chain and beyond the chain to be in direct contact with the material being comminuted.

28. An infeed system for a machine having a device used to comminute materials, the infeed system comprising a first end and a second end spaced a distance from the first end, the first and second ends spaced apart a distance adequate so that the infeed system is able to support the material, the infeed system including a conveyor system extending from second end to the first end capable of moving material in a direction from the second end towards the first end, the infeed system further having a rotary member disposed for rotation about a rotational axis, the rotary member being further disposed at the first end of the infeed system with a first portion of the rotary member extending a first distance radially outwardly in direct contact with the conveyor system to provide support for the conveyor system without directly contacting the material, the first portion having a first width, and a second portion of the rotary member extending radially outwardly at a second distance greater than the first distance so as to be constructed to directly contact the material, and wherein the conveyor is an open chain and the second portion of the rotary member is an extension of the first portion that supports the conveyor, the second portion extending radially outwardly from the rotational axis between the chain and beyond the chain to be in direct contact with the material being comminuted.

29. The infeed system of claim 28 wherein the first end is adjacent the device used to comminute the materials.

30. The infeed system of claim 28 wherein the first end is farthest from the device used to comminute the materials.

31. The infeed system of claim 30 wherein the second end of the infeed system has a second rotary member disposed disposed for rotation about another rotational axis, the second rotary member being further disposed at the second end of the infeed system with a first portion of the second rotary member extending a first distance radially outwardly in direct contact with the conveyor system to provide support for the conveyor system without directly contacting the material, the first portion of the second rotary member having a first width, and a second portion of the second rotary member extending radially outwardly at a second distance greater than the first distance of the second rotary member so as to be constructed to directly contact the material, and the second portion of the second rotary member is an extension of the first portion of the second rotary member that supports the conveyor, the second portion of the second rotary member extending radially outwardly from the rotational axis of the second rotary member between the chain and beyond the chain to be in direct contact with the material being comminuted.
